(19) United States
(12) Patent Application Publication
(10) Pub. No.: US 2016/0215203 A1
(43) Pub. Date: Jul. 28, 2016

(54) DEVELOPMENT AND CHARACTERIZATION OF DEGRADABLE CROSS-LINKING IN POLYVINYL ALCOHOL

(71) Applicant: SCHLUMBERGER TECHNOLOGY CORPORATION, Sugar Land, TX (US)

(72) Inventors: Shitong S. Zhu, Waban, MA (US); Han Li, College Station, TX (US)

(21) Appl. No.: 15/025,649

(22) PCT Filed: Oct. 23, 2014
(86) PCT No.: PCT/US14/61943

§ 371 Date: Mar. 29, 2016

Related U.S. Application Data
(60) Provisional application No. 61/894,591, filed on Oct. 23, 2013.

(51) Int. Cl. C09K 8/62; C09K 8/60

(52) U.S. Cl. CPC C09K 8/62; C09K 8/60

(57) ABSTRACT

A method of treating a subterranean formation penetrated by a wellbore by forming a treatment fluid that includes at least a polyvinyl alcohol polymer and a crosslinking agent selected from the group consisting of an aliphatic polyester, a semi-aromatic polyester, a derivative of polyalkylene glycol diacid, and combinations thereof. The treatment fluid is then introduced into the subterranean formation.

### CROSS-REFERENCE TO RELATED APPLICATION

This application claims the benefit of U.S. Provisional Application Ser. No. 61/894,591 filed Oct. 23, 2013 entitled “Development and Characterization of Degradable Cross-linking in PVOH” to Zhu et al. (Attorney Docket No. IS13.4371-US-PSP), the disclosure of the provisional application is incorporated by reference herein in their entirety.

### BACKGROUND

Water-soluble polymers have been used to modify fluid rheology, to disperse inorganic particles in fluids, and to function as temporary barriers or plugs. The solubility of these polymers mostly depends on temperature, and the dissolution may start when the polymer is in contact with water above a certain temperature. A water-soluble polymer may start to dissolve after a defined time in water at a certain temperature, i.e., having a delayed onset of dissolution. Such behavior can be quite beneficial for certain applications. The delayed onset of dissolution is introduced by crosslinking the hydroxyl group with hydrolysable crosslinkers. The hydrolysis of the crosslinker at higher temperature after a certain period of time results in the swelling of the polymer and later dissolution of the polymer into the fluid.

Well treatment fluids, particularly those used in fracturing, may comprise a water or oil based fluid incorporating a thickening agent, normally a polymeric material. Typical polymeric thickening agents for use in such fluids comprise galactomannan gums, such as guar and substituted guars such as hydroxypropyl guar and carboxymethylhydroxypropyl guar (CMHPG). Cellulosic polymers such as carboxymethyl cellulose may also be used, as well as synthetic polymers such as polyacrylamide. To increase the viscosity, and, therefore, the proppant carrying ability of the fracturing fluid, as well as increase its high temperature stability, the polymeric materials may be crosslinked. Crosslinking a polymer solution may increase the steady shear viscosity up to two orders of magnitude. For well stimulation treatments, particularly hydraulic fracturing, this may creating fracture width and transporting and place proppant in the fracture.

### BRIEF DESCRIPTION OF DRAWINGS

FIG. 1 shows a graphical representation of a DSC heating curve according to one or more embodiments described herein.

FIG. 2 shows a graphical representation of a DSC heating curve according to one or more embodiments described herein.

FIG. 3 shows a graphical representation of a DSC heating curve according to one or more embodiments described herein.

FIG. 4 shows a graphical representation of a DSC heating curve according to one or more embodiments described herein.

FIGS. 5A and 5B show graphical representations of TGA curves according to one or more embodiments described herein.

FIGS. 6A and 6B show graphical representations of TGA curves according to one or more embodiments described herein.

FIGS. 7A and 7B show graphical representations of TGA curves according to one or more embodiments described herein.

FIGS. 8A and 8B show graphical representations of TGA curves according to one or more embodiments described herein.

FIGS. 9A and 9B show graphical representations of TGA curves according to one or more embodiments described herein.

FIG. 10 shows a graphical representation of a TGA heating curve according to one or more embodiments described herein.

FIG. 11 shows a graphical representation of volume swelling according to one or more embodiments described herein.

FIG. 12 shows a graphical representation of gel content according to one or more embodiments described herein.

FIG. 13A-13D show images according to one or more embodiments described herein.

### SUMMARY

Disclosures relate to compositions and methods for treating subterranean formations, in particular, oilfield stimulation compositions and methods of forming a crosslinked treatment fluid comprised at least a polyvinyl alcohol polymer and a crosslinking agent selected from the group consisting of an aliphatic polyester, a semi-aromatic polyester, a derivative of polyalkylene glycol diacid, and combinations thereof, and introducing the crosslinked treatment fluid to the subterranean formation.

### DETAILED DESCRIPTION

At the outset, it should be noted that in the development of any such actual embodiment, numerous implementation-specific decisions may be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. Also, in the summary and this detailed description, it should be understood that a range listed or described as being useful, suitable, or the like, is intended to include support for any conceivable sub-range within the range at least because every point within the range, including the end points, is to be considered as having been stated. For example, “a range of from 1 to 10” is to be read as indicating each possible number along the continuum between about 1 and about 10. Furthermore, one or more of the data points in the present examples may be combined together, or may be combined with one of the data points in the specification to create a range, and thus include each possible value or number within this range. Thus, (1) even if numerous specific data points within the range are explicitly identified, (2) even if reference is made to a few specific data points within the range, or (3) even when no data points within the range are explicitly identified, it is to be understood (i) that the inventors appreciate and understand that any conceivable data point within the range is to be considered to have been specified, and (ii) that the inventors possessed knowledge of the entire range, each conceivable sub-range within the range, and each conceivable point within the range. Furthermore, the subject matter of this application illustratively disclosed herein suitably may be practiced in the absence of any element(s) that are not specifically disclosed herein.

The statements made herein merely provide information related to the present disclosure and may not constitute prior art, and may describe some embodiments illustrating the invention.

Treatment fluids may be used in a variety of subterranean treatments, including, but not limited to, stimulation treatments and sand control treatments. As used herein, the term “treatment,” or “treating,” refers to any subterranean operation that uses a fluid in conjunction with a desired function and/or for a desired purpose. The term “treatment,” or “treating,” does not imply any particular action by the fluid or any particular component thereof.

The present application relates to methods and compositions for treating subterranean formations. More particularly, the present application relates to method of treating subterranean formation treatment fluids by forming a crosslinked treatment fluid comprised at least a polyvinyl alcohol polymer and a crosslinking agent selected from the group consisting of an aliphatic polyester, a semi-aromatic polyester, a derivative of polyalkylene glycol diacid, and combinations thereof, and introducing the crosslinked treatment fluid to the subterranean formation.

As discussed in more detail below, polyvinyl alcohol may be cross-linked with one or more polyesters, such as, for example, aliphatic polyesters (e.g., polylactic acid) or derivatives of polyalkylene glycol (e.g., poly (ethylene glycol) bis (carboxy methyl) ether (PEGBC)) or fatty acid dimer and trimer to fabricate degradable polymers which can stay insoluble in water at low temperatures (room temperature or lower) and become swellable and soluble in water at high temperatures (greater than 60° C.) in fairly short time (a few hours). A metal fatty acid salt, such as zinc-2-ethylhexanoate (Zn octoate), may be used as a catalyst for catalyzing the cross-linking reactions. Thermo gravimetric analysis (TGA) and differential scanning calorimetry (DSC) may then be were used to characterize the properties of the cross-linked samples. Swelling studies and dissolution tests may be also conducted to study the behavior of cross-linked samples in water at different temperatures. As discussed in more detail below, these results demonstrate that (1) crosslinking is increased proportional to the amount of the metal fatty acid salt and (2) blending time and the order of addition of chemicals also strongly affect the cross-linking density in the samples. In addition, the cross-linked PVOH dissolve much slower than pure PVOH in water. The formation of cross-linking structures also affected the swelling behavior of PVOH.

In embodiments, the treatment fluid may contain a polyvinyl alcohol. As used herein, “polyvinyl alcohol resin,” “PVOH resin,” “PVOH polymer” and like terminology means polyvinyl alcohol resins which are may be prepared from polyvinyl acetate homopolymers or copolymers by saponification thereof which is well known in the art. PVOH resins are derived from homopolymers of vinyl acetate as well as copolymers of vinyl acetate with other ethylenically unsaturated monomers, and may include cationic sites if so desired.

The polyvinyl alcohol resins may be based on vinyl acetate homopolymer or copolymers of vinyl acetate with any suitable comonomer and/or blends thereof. PVOH resins employed in the present application are predominately (more than 50 mol %) based on vinyl acetate monomer which is polymerized and subsequently hydrolyzed to polyvinyl alcohol. Desirably, the resins are more than 75 mol % vinyl acetate derived, more than 95 mol % percent vinyl acetate derived, such as, for example, more than 99+mol % vinyl acetate derived. If used, comonomers may be present from about 0.1 to about 50 mol % with vinyl acetate and may include acrylic comonomers such as AMPS or salts thereof. Other suitable comonomers include glycol comonomers, vinyl versatate comonomers, ethylene comonomers, maleic or lactic acid comonomers, itaconic acid omonomers and so forth. Vinyl versatate including alkyl groups (veova) comonomers may likewise be useful. The comonomers may be grafted or co-polymerized with vinyl acetate as part of the backbone. Likewise, homopolymers may be blended with copolymers, if so desired.

Other examples may include modified polyvinyl alcohol (PVOH). PVOH may be prepared by polymerizing vinyl acetate, followed by hydrolysis of the acetate groups. The hydrolysis step can be controlled to occur to a desired extent such that the PVOH has a desired property—not soluble in water. Examples of such modified PVOH polymers are described in U.S. Pat. No. 5,137,969, the disclosure of which is incorporated by reference herein in its entirety. Specific examples of modified polyvinyl alcohols include a polyvinyl alcohol having one or more the hydroxyl groups replaced by one of more functional groups, such as, for example, acetates, alkyl groups, ethylene oxide, acetoacetyl, anionic (sulfonic, carboxyl), cationic groups, etcSome of these modified PVOH are sold by Celanese Chemicals (Dallas, Tex., U.S.A.) under the trade name of VYTEK. Some are sold by Nippon Gohsei under the trade name of Nichigo G-Polymer. Such PVOH are either water soluble or can be hydrolyzed by base to become water soluble. Similarly, low-viscosity latex, such as those supplied by Hexion Specialty Chemicals (Columbus, Ohio), may also be prepared to retain some functional groups such that it is not soluble in aqueous medium until such functional groups are hydrolyzed by base. These materials are described in a co-pending application Ser. No. 11/610,600, entitled “Fluid Loss Control Agent With Triggerable Removal Mechanism,” by Hoefer et al.

The polyvinyl alcohols or modified polyvinyl alcohols may have an average molecular weight of from about 10,000 to about 120,000, such as, for example, from about 10,000 to about 100,000, from about 15,000 to about 75,0000, and from 25,000 to about 50,000 Daltons.

In embodiments, the fluid may contain a PVOH that are crosslinked by a crosslinking agent. The phrase “cross linking agent” refers, for example, to a compound or mixture that assists in the formation of a three dimensional polymerized structure of the crosslinkable component under at least some downhole conditions. Suitable cross linking agents for the methods of the present disclosure would be capable of crosslinking polymer molecules to form a three-dimensional network. Suitable organic crosslinking agents include, but are not limited to, aliphatic or aromatic polyesters, derivatives of polyalkylene glycol, and combinations thereof. The concentration of the cross linking agent in the crosslinkable fluid may be from about 0.001 wt % to about 10 wt %, such as about 0.005 wt % to about 2 wt %, or about 0.01 wt % to about 1 wt %.

In embodiments, the components of the crosslinkable polymer may be selected so that the morphology of the crosslinked structure, which forms by crosslinking the crosslinkable polymer, may be tuned to provide the desired sealing function upon hydrolysis and swelling. Such morphologies of the crosslinked fluid system may include, for example, a gelled material such as an elastic gel, a rigid gel, etc.; a slurried material; an elastic solid; a rigid solid; a brittle solid; a foamed material, and the like.

The fluid containing the crosslinked polymers for treating a subterranean formation of the present disclosure may be a fluid that has a viscosity of above about 50 centipoise at 100 sec⁻¹, such as a viscosity of above about 100 centipoise at 100 sec⁻¹ at the treating temperature, which may range from a surface temperature to a bottom-hole static (reservoir) temperature, such as from about 4° C. to about 80° C., or from about 10° C. to about 70° C., or from about 25° C. to about 60° C., or from about 32° C. to about 55° C. In embodiments, the crosslinked structure formed may be a gel that is substantially non-rigid after substantial crosslinking. In some embodiments, crosslinked structure formed is a non-rigid gel may substantially return to its starting condition after compression with a linear strain of at least about 10%, such as at least about 25%, or greater than about 50%. Non-rigidity of which can be determined by any techniques known to those of ordinary skill in the art. The storage modulus G′ of substantially crosslinked polymer of the present disclosure, upon awelling in water, as measured according to standard protocols given in U.S. Pat. No. 6,011,075, the disclosure of which is hereby incorporated by reference in its entirety, may be about 150 dynes/cm² to about 500,000 dynes/cm², such as from about 1000 dynes/cm² to about 200,000 dynes/cm², or from about 10,000 dynes/cm² to about 150,000 dynes/cm².

After the fluid containing the crosslinked PVOH is prepared, it can be injected or conveyed into a subterranean formation to substantially seal at least a portion of the subterranean formation upon hydrolysis of the crosslinked bond that results in swelling of the polymers. In embodiments, at least some of the fluid permeates a portion of the subterranean formation, such as a water-bearing subterranean formation.

As discussed above, the crosslinking agent may be an aliphatic polyester. Nonlimiting examples of aliphatic polyesters that may be used include certain polymer materials that are capable of generating acids upon degradation. These polymer materials may herein be referred to as “polymeric acid precursors.” These materials may be solids at room temperature. The aliphatic polyesters include the polymers and oligomers that hydrolyze or degrade in certain chemical environments under known and controllable conditions of temperature, time and pH to release organic acid molecules that may be referred to as “monomeric organic acids.” As used herein, the expression “monomeric organic acid” or “monomeric acid” may also include dimeric acid or acid with a small number of linked monomer units that function similarly to monomer acids composed of a single monomer unit.

Additional examples of polyesters includes those polyesters obtained by polymerization of hydroxycarboxylic acids, such as the aliphatic polyester of lactic acid, referred to as polylactic acid; glycolic acid, referred to as polyglycolic acid; 3-hydroxbutyric acid, referred to as polyhydroxybutyrate; polyhydroxyalkanoate; 2-hydroxyvaleric acid, referred to as polyhydroxyvalerate; epsilon caprolactone, referred to as polyepsilon caprolactone or polyprolactone; the polyesters obtained by esterification of hydroxyl aminoacids such as serine, threonine and tyrosine; and the copolymers obtained by mixtures of the monomers listed above. A general structure for the above-described homopolyesters is:

H—{O—[C(R₁,R₂)]ₓ—[C(R₃,R₄)]_{y}—C═O}_{z}—OH

where,
R₁, R₂, R₃, R₄ is either H, linear alkyl, such as CH₃, CH₂CH₃ (CH₂)—CH₃, branched alkyl, aryl, alkylaryl, a functional alkyl group (bearing carboxylic acid groups, amino groups, hydroxyl groups, thiol groups, or others) or a functional aryl group (bearing carboxylic acid groups, amino groups, hydroxyl groups, thiol groups, or others);
x is an integer between 1 and 11;
y is an integer between 0 and 10; and
z is an integer between 2 and 50,000.

In the appropriate conditions (pH, temperature, water content) polyesters like those described herein can hydrolyze and degrade to yield hydroxycarboxylic acid and compounds that pertain to those acids referred to in the foregoing as “monomeric acids.”

One example of a suitable aliphatic polyester, as mentioned above, is the polymer of lactic acid, sometimes called polylactic acid, “PLA,” polylactate or polylactide. Lactic acid is a chiral molecule and has two optical isomers. These are D-lactic acid and L-lactic acid. The poly(L-lactic acid) and poly(D-lactic acid) forms are generally crystalline in nature. Polymerization of a mixture of the L- and D-lactic acids to poly(DL-lactic acid) results in a polymer that is more amorphous in nature. The polymers described herein are essentially linear. The degree of polymerization of the linear polylactic acid can vary from a few units (2-10 units) (oligomers) to several thousands (e.g. 2000-5000). Cyclic structures may also be used. The degree of polymerization of these cyclic structures may be smaller than that of the linear polymers. These cyclic structures may include cyclic dimers.

Another example is the polymer of glycolic acid (hydroxyacetic acid), also known as polyglycolic acid (“PGA”), or polyglycolide. Other materials suitable as polymeric acid precursors are those polymers of glycolic acid with itself or other hydroxy-acid-containing moieties, as described in U.S. Pat. Nos. 4,848,467; 4,957,165; and 4,986,355, which are herein incorporated by reference in their entireties.

The polylactic acid and polyglycolic acid may each be used as homopolymers, which may contain less than about 0.1% by weight of other comonomers. As used with reference to polylactic acid, “homopolymer(s)” is meant to include polymers of D-lactic acid, L-lactic acid and/or mixtures or copolymers of pure D-lactic acid and pure L-lactic acid. Additionally, random copolymers of lactic acid and glycolic acid and block copolymers of polylactic acid and polyglycolic acid may be used. Combinations of the described homopolymers and/or the above-described copolymers may also be used.

Other examples of polyesters of hydroxycarboxylic acids that may be used as polymeric acid precursors are the polymers of hydroxyvaleric acid (polyhydroxyvalerate), hydroxybutyric acid (polyhydroxybutyrate) and their copolymers with other hydroxycarboxylic acids. Polyesters resulting from the ring opening polymerization of lactones such as epsilon caprolactone (polyepsiloncaprolactone) or copolymers of hydroxyacids and lactones may also be used as polymeric acid precursors.

Polyesters obtained by esterification of other hydroxyl-containing acid-containing monomers such as hydroxyaminoacids may be used as polymeric acid precursors. Naturally occurring aminoacids are L-aminoacids. Among the 20 most common aminoacids the three that contain hydroxyl groups are L-serine, L-threonine, and L-tyrosine. These aminoacids may be polymerized to yield polyesters at the appropriate temperature and using appropriate catalysts by reaction of their alcohol and their carboxylic acid group. D-aminoacids are less common in nature, but their polymers and copolymers may also be used as polymeric acid precursors.

NatureWorks, LLC, Minnetonka, Minn., USA, produces solid cyclic lactic acid dimer called “lactide” and from it produces lactic acid polymers, or polylactates, with varying molecular weights and degrees of crystallinity, under the generic trade name NATUREWORKS PLA. The PLA's currently available from NatureWorks, LLC have number averaged molecular weights (Mn) of up to about 100,000 and weight averaged molecular weights (Mw) of up to about 200,000, although any polylactide (made by any process by any manufacturer) may be used. Those available from NatureWorks, LLC may have crystalline melt temperatures of from about 120 to about 170° C., but others are obtainable. Poly(d,l-lactide) at various molecular weights is also commercially available from Bio-Invigor, Beijing and Taiwan. Bio-Invigor also supplies polyglycolic acid (also known as polyglycolide) and various copolymers of lactic acid and glycolic acid, often called “polyglactin” or poly(lactide-co-glycolide).

The extent of the crystallinity can be controlled by the manufacturing method for homopolymers and by the manufacturing method and the ratio and distribution of lactide and glycolide for the copolymers. Additionally, the chirality of the lactic acid used also affects the crystallinity of the polymer. Polyglycolide can be made in a porous form. Some of the polymers dissolve very slowly in water before they hydrolyze.

Amorphous polymers may be useful in certain applications. An example of a commercially available amorphous polymer is that available as NATUREWORKS 4060D PLA or 6060D PLA, available from NatureWorks, LLC, which is a poly(DL-lactic acid) and contains approximately 12% by weight of D-lactic acid and has a number average molecular weight (Mn) of approximately 98,000 g/mol and a weight average molecular weight (Mw) of approximately 186,000 g/mol.

In embodiments, the crosslinking agent may also be semi-aromatic polyesters. The semi-aromatic polyesters may have a number-average molecular weight (Mn) of from 5000 g/mol and 20,000 g/mol. Furthermore, the semi-aromatic polyesters may be selected from the group consisting of polyesters obtained by polycondensation of at least one aromatic diacid or a corresponding diester with an aliphatic, cycloaliphatic or aromatic diol. The aromatic diacids and their diesters can be selected for example from terephthalic acid, dimethyl terephthalate, isophthalic acid, dimethyl isophthalate, 5-tert-butyl isophthalic acid, 4,4′-biphenyl dicarboxylic acid and isomers of dimethyl naphthalate. The diols can be selected for example from ethylene glycol, diethylene glycol, propylene glycol, butylene glycol, isosorbide and 1,4-cyclohexane dimethanol. Specific examples of crosslinking agents include polyethylene terephthalate (“PET”), poly(trimethylene terephthalate) (“PTT”), and polybutylene terephthalate (“PBT”), polyethylene naphthalene (“PNT”), and combinations thereof.

In embodiments, the crosslinking agent may also be a mixture of a fatty acid dimer and a fatty acid trimer. More specifically, the crosslinking agent may be a mixture of a fatty acid trimer and one or more diacids chosen from a linear alkyldicarboxylic acid such as glutaric acid, adipic acid, pimelic acid, suberic acid, azelaic acid, sebacic acid, undecanedioic acid, dodecanedioic acid, brassylic acid, tetradecanedioic acid, pentadecanedioic acid, thapsic acid or octadecanedioic acid, or branched such as 3,3-dimethylglutaric acid. The crosslinking agent may also be a mixture comprising 15% to 100% of fatty acid dimers, the remainder consisting of monomers and/or trimers and/or oligomers of higher fatty acids.

Examples of fatty acid dimers and trimers that may be mentioned include the compounds having the following formulae, which illustrate cyclic timers and dimers derived from fatty acids containing 18 carbon atoms, given that the commercially available compounds are mixtures of steric isomers and of positional isomers of these structures, optionally partially or totally hydrogenated.

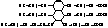

### Cyclic Trimer of C18 Acid

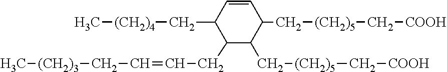

### Cyclic Dimer of C18 Acid

The crosslinking agent may also be made of a mixture of fatty acid oligomers containing dimers, trimers, higher oligomers and linear or cyclic C 18 fatty acid monomers, said mixture being predominantly dimers and trimers and containing a small percentage (less than 5%) of monomers and of higher oligomers. For example, the mixture may comprise: (1) 0% to 40% by weight, such as, for example, 0.1% to 5% by weight, of identical or different fatty acid monomers, (2) 0% to 10% by weight, such as, for example, 0% to 1% by weight, of identical or different higher fatty acid oligomers, (3) 0.1% to 99% by weight, such as, for example, 15% to 95% by weight, of identical or different fatty acid dimers, and (4) 0.1% to 90% by weight, such as, for example, 5% to 85% by weight, of identical or different fatty acid trimers. Furthermore, the mixture of molecules derived from fatty acids has an average molecular mass of greater than 500 g/mol.

Specific examples of fatty acid dimers/trimers mixtures that may be mentioned include (% by weight)
PRIPOL 1017 from Uniqema, mixture of 75-80% dimers and 18-22% trimers with about 1-3% fatty acid monomers,
PRIPOL 10.48 from Uniqema, 50/50% mixture of dimers/trimers,
PRIPOL 1013 from Uniqema, mixture of 95-98% dimers and 2-4% trimers with 0.2% maximum of fatty acid monomers,
PRIPOL 1006 from Uniqema, mixture of 92-98% dimers ax mum of 4% trimers with 0.4% maximum fatty acid monomers,
PRIPOL 1040 from Uniqema, mixture of fatty acid dimers and trimers with at least 75% trimers and less than 1%) fatty acid monomers,
UNIDYME 60 from Arizona Chemicals, mixture of 33% dimers and 67% trimers with less than 1% fatty acid monomers,
UNIDYME 40 from Arizona Chemicals, mixture of 65% dimers and 35% trimers with less than 1% fatty acid monomers,
UNIDYME 14 from Arizona Chemicals, mixture of 94% dimers and less than 5% trimers and other higher oligomers with about 1% fatty acid monomers,
EMPOL 1008 from Cognis, mixture of 92% dimers and of 3% higher oligomers, including essentially trimers, with about 5% fatty acid monomers,
EMPOL 1018 from Cognis, mixture of 81% dimers and 14% higher oligomers, including essentially trimers, with about 5% fatty acid monomers,
RADIACID 0980 from Oleon, mixture of dimers and trimers with at least 70% trimers.
RADIACID 0950 from Oleon, mixture of 79-85% fatty acid dimers and 13-19% fatty acid trimers with about 1-3% fatty acid monomers.
   The products PRIPOL, UNIDYME, EMPOL and RADIACID comprise C18 fatty acid monomers and fatty acid oligomers corresponding to C18 multiples.

In embodiments, the crosslinking agent may also be a derivative of polyalkylene glycol, the derivative being a monoester, diester, monoamine salt of the acid or of the half-ester, diamine salt, diamide or mixed ester/amide amine salts. Ester derivatives may be those prepared by reacting the diacid with monohydric aliphatic alcohols having about 6 to 30 carbon atoms, and the amine and amide derivatives may be prepared from C8-C40 primary, secondary, tertiary or quaternary amines or mixtures thereof.

Specific additives of this present application may be prepared from a polyethylene glycol dicarboxylic acid having a molecular weight (Mn, number average) of about 200 to 6,000, such as, for example, from about 400 to about 3,000 and from about 600 to about 2,000. Esters of this acid prepared from C₂₀-C₂₂ mixed linear aliphatic alcohols may be a derivative additive and these esters may be monoesters, diesters or mixtures thereof such as the mixed esters prepared by reacting the diacid and the mixed C₂₀-C₂₂ alcohols in a 1 to 1.5 molar ratio (diacid:alcohols). Another additive is the ester amine salt prepared by reacting the polyethylene glycol diacid (Mn 600), mixed C20-C22 linear alkanols and dihydrogenated tallow amine in a molar ratio of 1:1.5:0.5 (acid.alcohols:amine), to form an amine salt of the ester mixture. Another additive is the amine salt prepared by reacting the above diacid and amine in a molar ratio of 1:2.

The amines used in forming additives of this present application may be long chain C₁₂-C₄₀ secondary amines such as dioctadecyl amine, methyl behenyl amine and the like. One example is a secondary hydrogenated tallow amine of the formula HNR₁R₂ wherein R₁ and R₂ are alkyl groups derived from hydrogenated tallow fat composed of 4% C_{H}, 31% C_{J6} and 59% C₁₈ alkyl groups as the principal alkyl groups. Another specific examples of the polyalkylene glycol include poly (ethylene glycol) bis (carboxy methyl) ether (PEGBC), O,O′-bis[2-(succinylamino)ethyl]polyethylene glycol (Mr from 2000 to 10000), O,O′-bis(2-carboxyethyl)dodecaethylene glycol, O,O′-oxydiethylene-diglycolic acid, 3,6,9-Trioxaundecanedioic acid, diglycolic acid.

In embodiments, the crosslinking reaction may further include a metal catalyst. For example, the catalyst may be a catalyst suitable for transesterification or esterification. Examples of suitable metal catalysts include metal (zinc, tin and zirconium) salts of fatty acids. Specific examples include tin (II) naphthanate, tin (II) octoate, tin (II) oxalate, tin (II) oleate, tin (II) butyrate, tin (II) acetylacetonate, titanium naphthanate, zinc naphthanate, cobalt naphthanate, zinc stearate, zinc undecylenate, zinc distearate, zinc acetylacetonate, butyltin-tri-2-ethylhexoate, dibutyltin diacetate, dibutyltin dilaurate, dibutyltin dioctate, dibutyltin diolate, lead-2-ethylhexanoate, zinc-2-ethylhexanoate, or similar metal salts of a carboxylic acid; tetrabutyl titanate, tetra-2-ethylhexyl titanate, tetraoctadecyl titanate, tetraphenyl titanate, tetra(isopropenyloxy) titanate, or a similar organic titanic acid esters.

As a compound that acts as a catalyst, specifically, titanium compounds, tin compounds, aluminum compounds, calcium compounds, lithium compounds, magnesium compounds, cobalt compounds, manganese compounds, antimony compounds, germanium compounds, zinc compounds, and the like are may be employed because they are highly reactive and can increase the reaction rate and yield of the resulting polyester. Additional examples of catalysts include alkali metal acetates, and examples of crosslinking catalysts include calcium oxide, zinc oxide, nickel oxide, aluminum oxide, magnesium oxide, tin (II) oxide, germanium oxide, antimony oxide with little contamination, for example, by bismuth, in addition, transition metal compounds such as cobalt, and alkoxy titanate. Among them, titanium compounds, tin compounds, aluminum compounds, antimony compounds, and germanium compounds may be used because the reaction time can be reduced to achieve efficient production; titanium compounds and/or tin compounds may be employed because crystallization properties are easily controlled and a polyester having excellent qualities such as thermal stability, hydrolysis resistance, and thermal conductivity can be obtained; and titanium compounds are considered to be environmentally friendly. Examples of titanium compounds include titanic acid esters such as tetra-n-propyl ester, tetra-n-butyl ester, tetraisopropyl ester, tetraisobutyl ester, tetra-tert-butyl ester, cyclohexyl ester, phenyl ester, benzyl ester, tolyl ester, and mixed-esters thereof. Examples of tin compounds include monobutyltin oxide, dibutyltin oxide, methylphenyltin oxide, tetraethyltin oxide, hexaethylditin oxide, cyclohexahexylditin oxide, didodecyltin oxide, triethyltin hydroxide, triphenyltin hydroxide, triisobutyltin acetate, dibutyltin diacetate, diphenyltin dilaurate, monobutyltin trichloride, dibutyltin dichloride, tributyltin chloride, dibutyltin sulfide, butylhydroxytin oxide, methyl stannoic acid, ethyl stannoic acid, and butyl stannoic acid, among which, in particular, monoalkyltin compounds may be used because polyesters can be efficiently produced. Such compounds that act as a catalyst may be used alone or in combination in the esterification reaction or transesterification reaction and the subsequent polycondensation reaction. For the timing of addition, any method such as adding immediately after the addition of raw materials, adding together with raw materials, or adding during the reaction can be used.

In embodiments, the treatment fluid of the present disclosure may further comprise one or more components such as, for example, a gel breaker, a buffer, a proppant, a clay stabilizer, a gel stabilizer, a chelating agent, an oxygen scavenger and a bactericide. Furthermore, the treatment fluid or treatment fluid may include buffers, pH control agents, and various other additives added to promote the stability or the functionality of the fluid. The treatment fluid or treatment fluid may be based on an aqueous or non-aqueous solution. The components of the treatment fluid or treatment fluid may be selected such that they may or may not react with the subterranean formation that is to be treated.

In this regard, the treatment fluid may include components independently selected from any solids, liquids, gases, and combinations thereof, such as slurries, gas-saturated or non-gas-saturated liquids, mixtures of two or more miscible or immiscible liquids, and the like, as long as such additional components allow for the formation of a polymeric structure. For example, the fluid or treatment fluid may comprise organic chemicals, inorganic chemicals, and any combinations thereof. Organic chemicals may be monomeric, oligomeric, polymeric, crosslinked, and combinations, while polymers may be thermoplastic, thermosetting, moisture setting, elastomeric, and the like. Inorganic chemicals may be metals, alkaline and alkaline earth chemicals, minerals, and the like. Fibrous materials may also be included in the fluid or treatment fluid. Suitable fibrous materials may be woven or nonwoven, and may be comprised of organic fibers, inorganic fibers, mixtures thereof and combinations thereof.

Surfactants can be added to promote dispersion or emulsification of components of the fluid, or to provide foaming of the crosslinked component upon its formation downhole. Suitable surfactants include alkyl polyethylene oxide sulfates, alkyl alkylolamine sulfates, modified ether alcohol sulfate sodium salts, or sodium lauryl sulfate, among others. Any surfactant which aids the dispersion and/or stabilization of a gas component in the fluid to form an energized fluid can be used. Viscoelastic surfactants, such as those described in U.S. Pat. No. 6,703,352, U.S. Pat. No. 6,239,183, U.S. Pat. No. 6,506,710, U.S. Pat. No. 7,303,018 and U.S. Pat. No. 6,482,866, each of which are incorporated by reference herein in their entirety, are also suitable for use in fluids in some embodiments. Examples of suitable surfactants also include, but are not limited to, amphoteric surfactants or zwitterionic surfactants. Alkyl betaines, alkyl amido betaines, alkyl imidazolines, alkyl amine oxides and alkyl quaternary ammonium carboxylates are some examples of zwitterionic surfactants. An example of a useful surfactant is the amphoteric alkyl amine contained in the surfactant solution AQUAT 944 (available from Baker Petrolite of Sugar Land, Tex.). A surfactant may be added to the fluid in an amount in the range of about 0.01 wt. % to about 10 wt. %, such as about 0.1 wt. % to about 2 wt. % based upon total weight of the treatment fluid.

Charge screening surfactants may be employed. In some embodiments, the anionic surfactants such as alkyl carboxylates, alkyl ether carboxylates, alkyl sulfates, alkyl ether sulfates, alkyl sulfonates, α-olefin sulfonates, alkyl ether sulfates, alkyl phosphates and alkyl ether phosphates may be used. Anionic surfactants have a negatively charged moiety and a hydrophobic or aliphatic tail, and can be used to charge screen cationic polymers. Examples of suitable ionic surfactants also include, but are not limited to, cationic surfactants such as alkyl amines, alkyl diamines, alkyl ether amines, alkyl quaternary ammonium, dialkyl quaternary ammonium and ester quaternary ammonium compounds. Cationic surfactants have a positively charged moiety and a hydrophobic or aliphatic tail, and can be used to charge screen anionic polymers such as CMHPG. In the same manner, a charged surfactant can also be employed to form polymer-surfactant complexes as a method for generating consolidated structures.

The treatment fluids described herein may also include one or more inorganic salts. Examples of these salts include water-soluble potassium, sodium, and ammonium salts, such as potassium chloride, ammonium chloride or tetramethyl ammonium chloride (TMAC). Additionally, sodium chloride, calcium chloride, potassium chloride, sodium bromide, calcium bromide, potassium bromide, sodium sulfate, calcium sulfate, sodium phosphate, calcium phosphate, sodium nitrate, calcium nitrate, cesium chloride, cesium sulfate, cesium phosphate, cesium nitrate, cesium bromide, potassium sulfate, potassium phosphate, potassium nitrate salts may also be used. Any mixtures of the inorganic salts may be used as well. The inorganic salt may be added to the fluid in an amount of from about 0.01 wt. % to about 80 wt. %, from about 0.1 wt. % to about 20 wt. %, from about 0.1 wt. % to about 10 wt. %, based upon total weight of the treatment fluid.

In other embodiments, the surfactant is a blend of two or more of the surfactants described above, or a blend of any of the surfactant or surfactants described above with one or more nonionic surfactants. Examples of suitable nonionic surfactants include, but are not limited to, alkyl alcohol ethoxylates, alkyl phenol ethoxylates, alkyl acid ethoxylates, alkyl amine ethoxylates, sorbitan alkanoates and ethoxylated sorbitan alkanoates. Any effective amount of surfactant or blend of surfactants may be used in aqueous energized fluids.

Friction reducers may also be incorporated in any fluid embodiment. Any suitable friction reducer polymer, such as polyacrylamide and copolymers, partially hydrolyzed polyacrylamide, poly(2-acrylamido-2-methyl-1-propane sulfonic acid) (polyAMPS), and polyethylene oxide may be used. Commercial drag reducing chemicals such as those sold by Conoco Inc. under the trademark “CDR” as described in U.S. Pat. No. 3,692,676 or drag reducers such as those sold by Chemlink designated under the trademarks FLO1003, FLO1004, FLO1005 and FLO1008 have also been found to be effective. These polymeric species added as friction reducers or viscosity index improvers may also act as excellent fluid loss additives reducing or even eliminating the use of conventional fluid loss additives. Latex resins or polymer emulsions may be incorporated as fluid loss additives. Shear recovery agents may also be used in embodiments.

Embodiments may also include proppant particles that are substantially insoluble in the fluids of the formation. Proppant particles carried by the treatment fluid remain in the fracture created, thus propping open the fracture when the fracturing pressure is released and the well is put into production. Suitable proppant materials include, but are not limited to, sand, walnut shells, sintered bauxite, glass beads, ceramic materials, naturally occurring materials, or similar materials. Mixtures of proppants can be used as well. If sand is used, it may be from about 20 to about 100 U.S. Standard Mesh in size. With synthetic proppants, mesh sizes about 8 or greater may be used. Naturally occurring materials may be underived and/or unprocessed naturally occurring materials, as well as materials based on naturally occurring materials that have been processed and/or derived. Suitable examples of naturally occurring particulate materials for use as proppants include: ground or crushed shells of nuts such as walnut, coconut, pecan, almond, ivory nut, brazil nut, etc.; ground or crushed seed shells (including fruit pits) of seeds of fruits such as plum, olive, peach, cherry, apricot, etc.; ground or crushed seed shells of other plants such as maize (e.g., corn cobs or corn kernels), etc.; processed wood materials such as those derived from woods such as oak, hickory, walnut, poplar, mahogany, etc., including such woods that have been processed by grinding, chipping, or other form of particulation, processing, etc.

The concentration of proppant in the fluid can be any concentration known in the art. For example, the concentration of proppant in the fluid may be in the range of from about 0.03 to about 3 kilograms of proppant added per liter of liquid phase. Also, any of the proppant particles can further be coated with a resin to potentially improve the strength, clustering ability, and flow back properties of the proppant.

A fiber component may be included in the fluids to achieve a variety of properties including improving particle suspension, and particle transport capabilities, and gas phase stability. Furthermore, any one of the materials identified herein may be represented as a particulate, particle or fiber, if appropriate, and may be encapsulated or coated depending on the situation. Fibers used may be hydrophilic or hydrophobic in nature. Fibers can be any fibrous material, such as, for example, natural organic fibers, comminuted plant materials, synthetic polymer fibers (by non-limiting example polyester, polyaramide, polyamide, novoloid or a novoloid-type polymer), fibrillated synthetic organic fibers, ceramic fibers, inorganic fibers, metal fibers, metal filaments, carbon fibers, glass fibers, ceramic fibers, natural polymer fibers, and any mixtures thereof. Particularly useful fibers are polyester fibers coated to be highly hydrophilic, such as, but not limited to, DACRON® polyethylene terephthalate (PET) fibers available from Invista Corp. Wichita, Kans., USA, 67220. Other examples of useful fibers include, but are not limited to, polylactic acid polyester fibers, polyglycolic acid polyester fibers, polyvinyl alcohol fibers, and the like. When used in fluids, the fiber component may be included at concentrations from about 1 to about 15 grams per liter of the liquid phase of the fluid, such as a concentration of fibers from about 2 to about 12 grams per liter of liquid, or from about 2 to about 10 grams per liter of liquid.

Embodiments may further use fluids containing other additives and chemicals that are known to be commonly used in oilfield applications by those skilled in the art. These include materials such as surfactants in addition to those mentioned hereinabove, breaker aids in addition to those mentioned hereinabove, oxygen scavengers, alcohol stabilizers, stabilizing agents, scale inhibitors, corrosion inhibitors, fluid-loss additives, bactericides and biocides such as 2,2-dibromo-3-nitrilopropionamine or glutaraldehyde, and the like. Also, they may include a co-surfactant to optimize viscosity or to minimize the formation of stable emulsions that contain components of crude oil.

As used herein, the term “alcohol stabilizer” is used in reference to a certain group of organic molecules substantially or completely soluble in water containing at least one hydroxyl group, which are susceptible of providing thermal stability and long term shelf life stability to aqueous zirconium complexes. Examples of organic molecules referred as “alcohol stabilizers” include but are not limited to methanol, ethanol, n-propanol, isopropanol, n-butanol, tert-butanol, ethyleneglycol monomethyl ether and the like.

Stabilizing agents can be added to slow the degradation of the polymeric structure after its formation downhole. Typical stabilizing agents may include buffering agents, such as agents capable of buffering at pH of about 8.0 or greater (such as water-soluble bicarbonate salts, carbonate salts, phosphate salts, or mixtures thereof, among others); and chelating agents (such as ethylenediaminetetraacetic acid (EDTA), nitrilotriacetic acid (NTA), or diethylenetriaminepentaacetic acid (DTPA), hydroxyethylethylenediaminetriacetic acid (HEDTA), or hydroxyethyliminodiacetic acid (HEIDA), among others). Buffering agents may be added to the treatment fluid in an amount of at least about 0.05 wt. %, such as from about 0.05 wt. % to about 10 wt. %, and from about 0.1 wt. % to about 2 wt. %, based upon the total weight of the treatment fluid. Chelating agents may be added to the treatment fluid in an amount of at least about 0.75 mole per mole of metal ions expected to be encountered in the downhole environment, such as at least about 0.9 mole per mole of metal ions, based upon the total weight of the treatment fluid.

Specific embodiments of the present disclosure will now be described in detail with reference to the accompanying drawings. Further, in the following detailed description of embodiments of the present disclosure, numerous specific details are set forth in order to provide a more thorough understanding of the presently claimed subject matter. However, it will be apparent to one of ordinary skill in the art that the embodiments disclosed herein may be practiced without these specific details. In other instances, well-known features have not been described in detail to avoid unnecessarily complicating the description.

### Examples

Several grades of G-Polymer, a modified PVOH (OKS-1011, 1027P, 8070P and 8042P) were supplied by SOARUS L.L.C. It is noted that 8042P and 8070P comprise glycerol as plasticizers. 8042P, OKS-1011, 1027P and 8070P G-polymer pellets were cyrogrinded (6870 Freezer Mill, SPEX SamplePrep L.L.C) to fine particles which are easy to be blended and extruded. 6060D, a polylactic acid (PLA) resin, were purchased from NatureWorks L.L.C. Zinc-2-ethylhexanoate (99%) (ZnOct), purchased from STREM Chemicals, was used as a catalyst for controlling the cross-linking reactions. Poly (ethylene glycol) bis (carboxy methyl) ether (PEGBC) was purchased from ALDRICH. Trimer acid crosslinker (PRIPOL™ 1040-LQ-(GD)) was provided by Croda Europe Limited Table 1 summarizes the properties of the chemicals used in the below examples.

TABLE 1
Physical properties of chemicals used in the experiments

| | Melting | Specific | Molecular formula/Molecular |
|---|---|---|---|
| Name | point | gravity | structure |
| 1027P OKS- 1011 8042P 8070P | 205.14 206.45 182.32 168.5 | 1.1-1.3 1.1-1.3 1.1-1.3 1.1-1.3 | 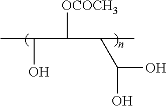 |
| 6060D | ND | 1.24 | 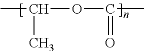 |
| PEGBC | ND | ND | 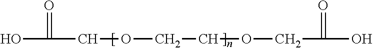 [SMILES: O=C(O)COCCOCC(=O)O] |
| Timer | ND | 1.0 g/cm3 | |
| acid | | | |
| (Tacid) | | | |
| ZnOct | ND | ND | C₁₆H₃₀O₄Zn |

### Sample Preparations

G-polymers and 6060D were dried in an oven at 87.5° C. and 60.5° C. respectively overnight before blending. G-polymer samples with different content of 6060D, ZnOct, glycerol, trimer acid and GEGBC were mixed in a Haake minilab mixer at the temperatures ranging from 180° C.-210° C. for 4-8 minutes before being extruded to form a rod. Some samples are post cured at 205° C. for 30 min to 1 hour.

### Characterization Methods

### Differential Scanning Calorimetry (DSC)

The thermal properties of the samples were measured by DSC (TA instruments Q200). Specimens of 8-10 mg were placed in an aluminum sample pan. The specimens were heated from 20° C. to 250° C. at a 20.00° C./min heating rate to remove any prior thermal history. The specimens were then cooled to −20.00° C. at a cooling rate of 20.00° C./min. After holding at −20.00° C. for 5 min, the specimens were heated to 250.00° C. with a heating rate of 10.00° C./min and cooled down to room temperature with a cooling rate of 20.00° C./min. The melting point (Tₘ), glass transition temperatures (T_{g}), cold crystallization temperatures (T_{cc}), enthalpy of cold crystallization (ΔH_{c}) and enthalpy of melting (ΔHₘ) of each sample were measured.

### Thermogravimetric Analysis (TGA)

TGA is routinely used to characterize thermal stabilities of polymers. TGA was performed using TGA Q 500 (TA instruments). The samples (10-20 mg) were held at 100° C. for 10 minutes at first to remove any residual water and then were heated from 100° C. to 600° C. (heating rate: 10° C./min) under nitrogen (flow rate: 40 ml/min) or air (flow rate: 60 ml/min) conditions.

### Degree of Swelling

The length, the perimeter, and the weight of each cylindrical sample were measured before and after swelling in DI water at room temperature (25° C.) and 87.5° C. for different time. The water on the surface of the wet samples was carefully removed with a clean tissue. The degree of swelling and the gel content was calculated using the following equations:

$$\begin{matrix}{DS}_{v} ( \% ) = \frac{{l}_{s} * {p}_{s}^{2} - {l}_{0} * {p}_{0}^{2}}{{l}_{0} * {p}_{0}^{2}} * 100 \% & ( 1 ) \\ Gel ( \% ) = \frac{{M}_{s}}{{M}_{0}} * 100 \% & ( 2 )\end{matrix}$$

Where l₀ and lₛ are the lengths of dry samples and the wet samples respectively, p₀ and pₛ are the perimeters of the dry samples and the wet samples respectively; M₀ and Mₛ are the weights of the dry samples and the wet samples respectively.

### Cross-Linking Reactions

Both esterification and transesterification reactions take place in the cross-linking of PLA and G-polymers. As shown in below, reaction (a) is the transesterification between the ester of 6060D and the hydroxyl groups of G-polymer. Reaction (b) shows the breakage of the ester bonds in 6060D to generate acid and hydroxyl groups and then the acid end groups react with the OH groups on G-polymer to form new ester bonds via esterification reactions. Water is from the moisture in air. ZnOct, as a catalyst, is used to control the esterification kinetics which can accelerate the process of breaking ester bonds and forming cross-linking networks.

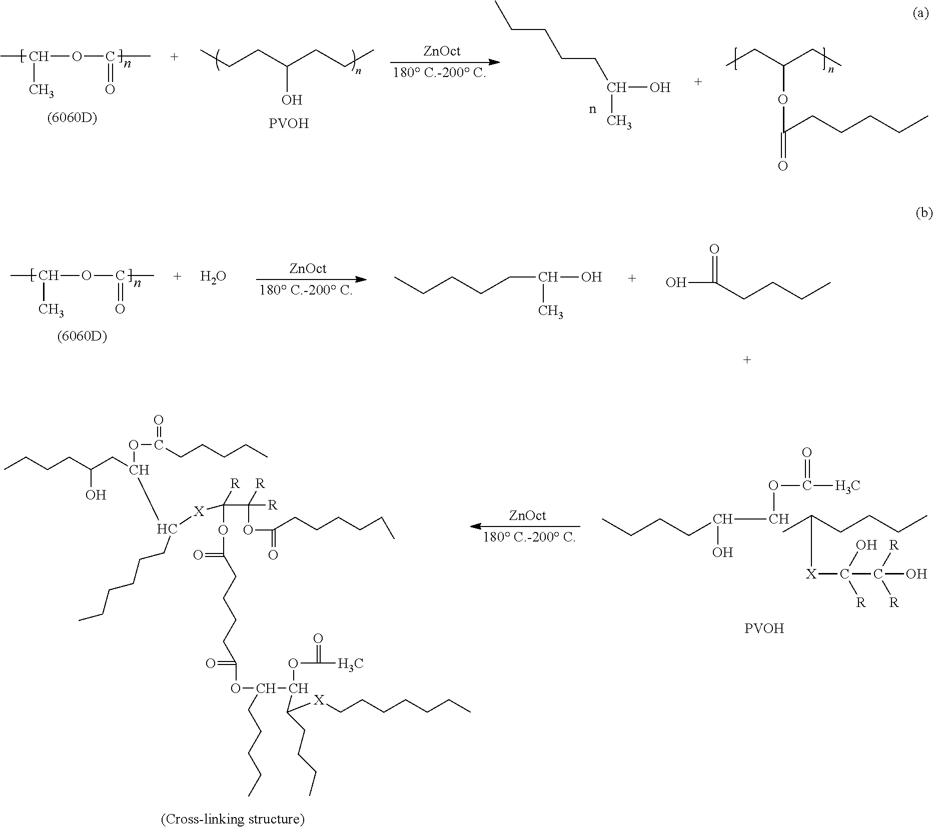

For the cross-linking reaction of G-polymers and PEGBC, as shown below, the carboxylic acid end groups on PEGBC and hydroxyl groups on G-polymers formed ester bonds to build the cross-linking networks. The reacting processes were conducted under 180-200° C. depending on the melting points and the onset temperature of thermal degradation for each chemicals.

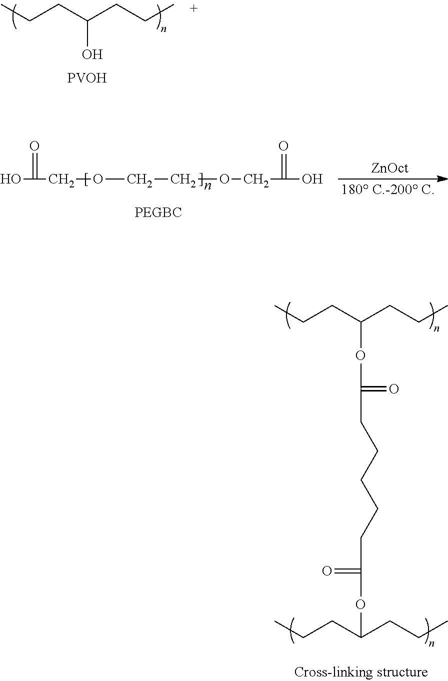

### Thermal Properties

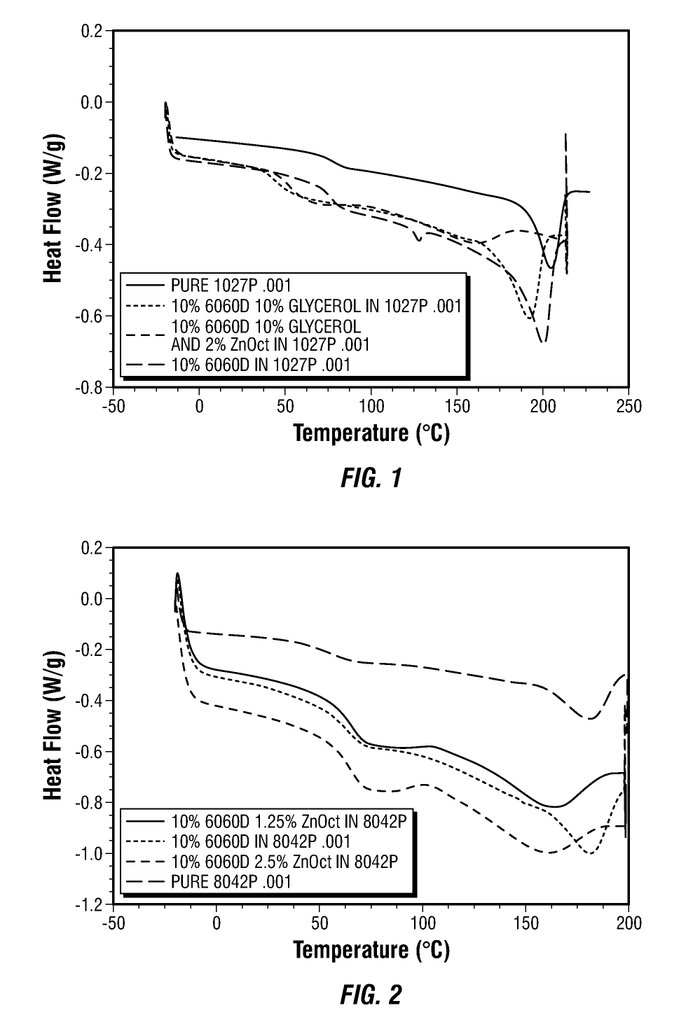

The DSC plots of cross-linked 1027P/6060D samples can be seen in FIG. 1, and Tₘ, T_{g}, T_{cc}, ΔH_{c}, ΔHₘ and the degree of crystallinity of PVOH (X_{c}) (from the 2^{nd} heating curve) are in Table 3. In sample 2 and sample 3, 10% glycerol was added as plasticizer. The X_{c} was calculated using the equation 1:

$${X}_{c} = \frac{Δ {H}_{m} - Δ {H}_{c}}{w Δ {H}_{m}^{0}} \qquad ( 1 )$$

Where w is the weight fraction of PVOH in the composites, ΔHₘ⁰ is the enthalpy of melting of 100% crystalline PVOH which has a value of 150 J/g. FIG. 1 contains the second heating cycle. The DSC results of pure 1027P are also shown for comparison.

TABLE 2
Thermal properties of cross-linked 6060D/1027P samples

| | T_{g} | T_{cc} | ΔHc | Tₘ | ΔHₘ | X_{c} |
|---|---|---|---|---|---|---|
| Sample | (° C.) | (° C.) | (J/g) | (° C.) | (J/g) | (%) |
| 1. 10% 6060D in | 72.5 | 127.77 | 0.7081 | 200.72 | 28.99 | 0.2095 |
| 1027P | | | | | | |
| 2. 10% 6060D | 44.87 | n/a | n/a | 192.95 | 25.06 | 0.2089 |
| 10% gly in 1027P | | | | | | |
| 3. 10% 6060D | 50.42 | n/a | n/a | 156.17 | 9.393 | 0.0696 |
| 10% gly 2% | | | | | | |
| ZnOct in 1027P | | | | | | |
| Pure 1027P | 77.97 | n/a | n/a | 205.14 | 34.28 | n/a |

As shown in FIG. 1 and in Table 2, the glass transition temperatures for sample 2 and sample 3 are much lower than that for sample 1 due to the plasticizing effect of glycerol. Moreover, the degree of crystallinity tends to decrease with the addition of ZnOct. This is caused by the large molecular chain networks with a high crosslink density which inhibits the motion of the chain segment for crystallization. Resulting from the lower degree of crystallinity, the samples with high cross-linking density also tend to have lower melting temperatures.

The DSC plots and data of cross-linked 6060D/8042P samples with different content of ZnOct are shown in FIG. 2 and Table 3. The melting endotherm peaks are gradually diminishing with the increase of ZnOct. This indicates that the crystallization of samples becomes more and more difficult. The lower melting temperature may also be caused by the imperfect crystal, which resulted from the confinement of the cross-linking structure. The similar effect can also be found in other cross-linked samples of 6060D with other type of G-polymers, such as 8070P and 1027P.

TABLE 3
Thermal properties of cross-linked 6060D/8042P samples

| | T_{g} | T_{cc} | ΔHc | Tₘ | ΔHm | X_{c} |
|---|---|---|---|---|---|---|
| Sample | (° C.) | (° C.) | (J/g) | (° C.) | (J/g) | (%) |
| 1. 10% 6060D in | 63.27 | n/a | 0.6002 | 182.36 | 13.65 | 9.7% |
| 8042P | | | | | | |
| 2. 10% 6060D | 66.16 | n/a | 0 | 166.19 | 10.57 | 7.8% |
| 1.25% ZnOct in | | | | | | |
| 8042P | | | | | | |
| 3. 10% 6060D | 65.69 | 100.69 | 0.8889 | 162.44 | 8.63 | 5.7% |
| 2.5% ZnOct in | | | | | | |
| 8042P | | | | | | |
| 4. Pure 8042P | 53.24 | n/a | 0 | 182.32 | 19.37 | 12.9% |

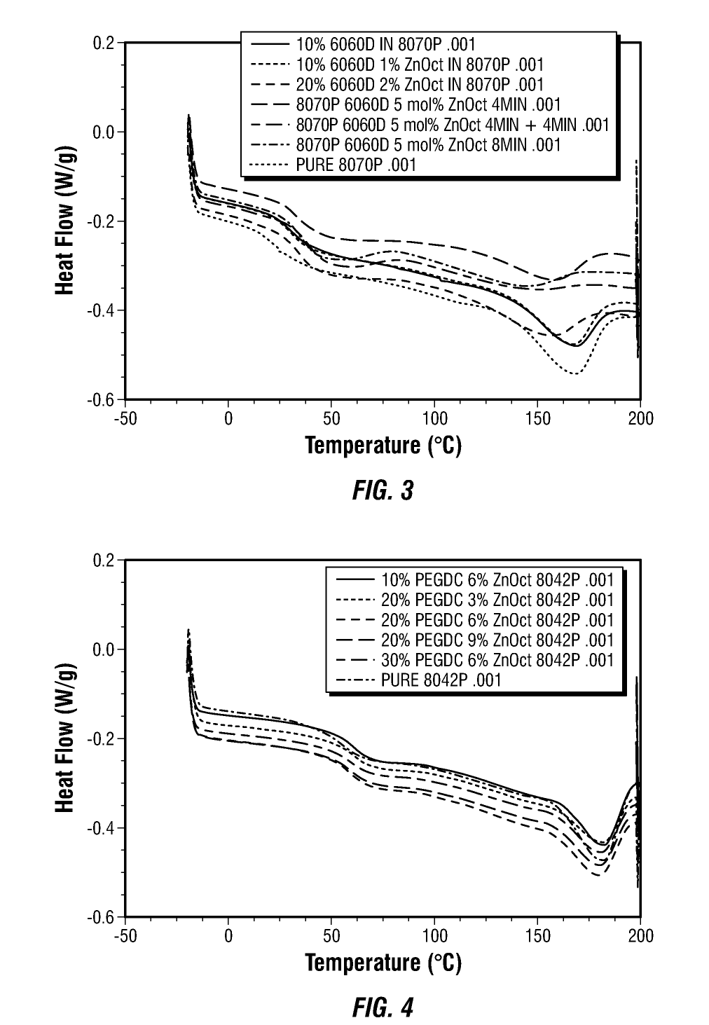

The cross-linked 8070p/6060D sample was also characterized by DSC tests with the same parameters (Table 4 and FIG. 3). The sample 5, 6 and 7 are in the same composition with different blending time and methods. The length of time in the brackets in Table 4 is the total blending time. For sample 7, 4 min+4 min means that the mixture of ZnOct and 6060D was first blended for 4 minutes, and then poured 8070P into the blender for another 4 minutes of blending. It indicates that the crosslinking density in sample 7 is apparently higher than the crosslinking density in sample 5 and 6. It may be resulted from the more efficient catalyzing during 4 minutes pre-blending of PLA and ZnOct which can break more ester bonds for crosslinking

TABLE 4
Thermal properties of cross-linked 6060D/8070P samples

| | T_{g} | Tₘ | ΔHm | X_{c} |
|---|---|---|---|---|
| Sample | (° C.) | (° C.) | (J/g) | (%) |
| 1. pure 8070P | 23.81 | 168.5 | 24.66 | 16.4% |
| 2. 10% 6060D in 8070P | 31.23 | 168.62 | 15.26 | 11.3% |
| 3. 10% 6060D 1% | 29.53 | 167.57 | 15.36 | 11.4% |
| ZnOct in 8070P | | | | |
| 4. 20% 6060D | 33.91 | 155.92 | 12.58 | 10.75% |
| 2% ZnOct in 8070P | | | | |
| 5. 20% 6060D | 34.34 | 157.78 | 13.36 | 12.20% |
| 7% ZnOct in 8070P | | | | |
| (4 min compounding | | | | |
| time) | | | | |
| 6. 20% 6060D | 35.64 | 144.03 | 8.976 | 5.72% |
| 7% ZnOct in 8070P | | | | |
| (8 min compounding | | | | |
| time) | | | | |
| 7. 20% 6060D | 39.65 | 147.77 | 3.289 | 0.73% |
| 7% ZnOct in | | | | |
| 8070P (4 + 4 min) | | | | |

FIG. 4 shows the 2^{nd} DSC heating curves for cross-linked PEGBC/8042P samples. The corresponding thermal parameters are in Table 5. Varying the amount of ZnOct or PEGBC has little impact on the thermal properties of the resultant samples. Compared with pure 8042P, other thermal parameters remain constant at the same blending temperature and blending time despite the change of the amount of ZnOct and PEGBC. This may be caused by the degradation of PEGBC during the blending.

TABLE 5
Thermal properties of 8042P/PEGBC cross-linked samples

| | T_{g} | Tₘ | ΔHm | X_{c} |
|---|---|---|---|---|
| Sample | (° C.) | (° C.) | (J/g) | (%) |
| Pure 8042P | 53.22 | 182.28 | 14.6 | 13.7% |
| 10% PEGBC & | 59.98 | 182.72 | 12.78 | 11.2% |
| 3% ZnOct in 8042P | | | | |
| 30% PEGBC & | 60.3 | 181.31 | 11.22 | 13.3% |
| 6% ZnOct in 8042P | | | | |
| 20% PEGBC & | 60.19 | 182.19 | 13.84 | 9.7% |
| 3% ZnOct in 8042P | | | | |
| 20% PEGBC & | 59.86 | 180.8 | 12.51 | 12.5% |
| 6% ZnOct in 8042P | | | | |
| 20% PEGBC & | 59.61 | 180.92 | 20.5 | 11.7% |
| 9% ZnOct in 8042P | | | | |

Table 6 shows the DSC data of crosslinked OKS-1011 with trimer acid as the crosslinker. The trend of decreasing Tm and Xc was observed in the crosslinked samples as well.

TABLE 6
Thermal properties of G-1011/
Tacid cross-linked samples

| | T_{g} | Tₘ | ΔHₘ | X_{c} |
|---|---|---|---|---|
| Sample | (° C.) | (° C.) | (J/g) | (%) |
| G1011A | 71.92 | 207.11 | 48.51 | 32.3% |
| G1011-Tacid- | 72.95 | 204.53 | 38.91 | 25.9% |
| ZnOct (3%) | | | | |

### TGA Analysis

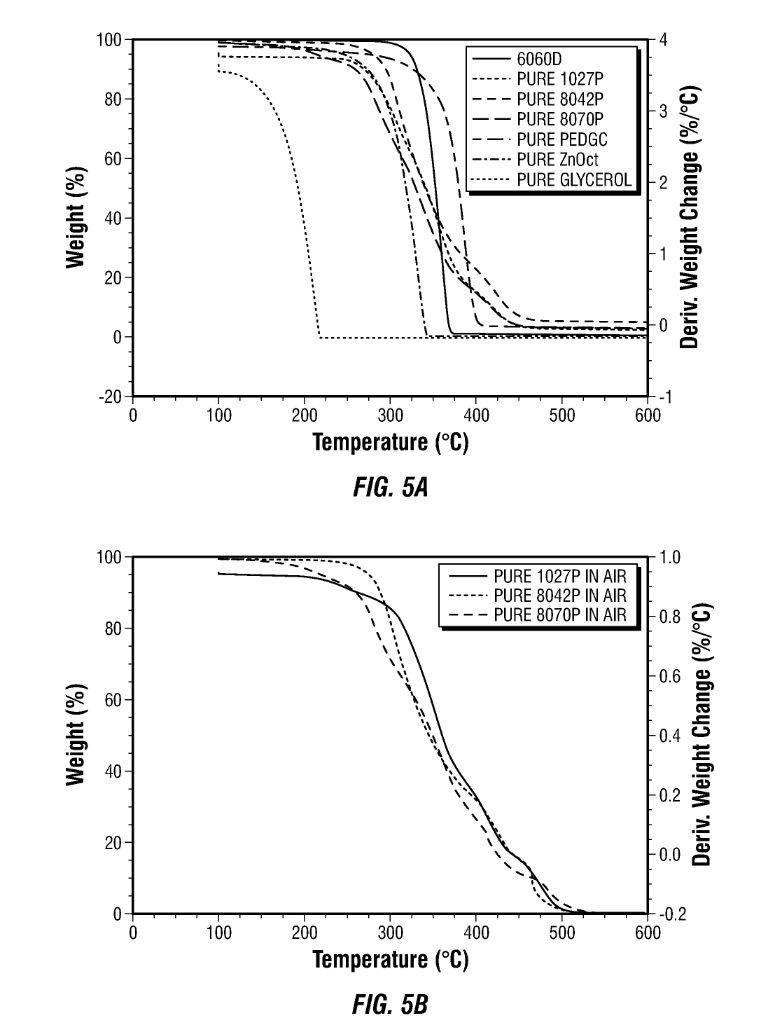

Thermal stability of pure 1027P, 8042P, OKS-1011 and 8070P, determined by TGA under nitrogen and oxygen, is shown in FIG. 5. The TGA curves for 6060D, glycerol and ZnOct are also shown in FIG. 5 for comparison and further references. The corresponding statistics are also shown in Table 7. The slightly weight loss of G-polymers between 100° C. to 250° C., was caused by the loss of the bound water molecules. This is a common observation of TGA analysis which is also shown in the TGA curves for other cross-linked samples. The onset temperatures of thermal degradation of pure 1027P, 8042P and 8070P were approximately 255° C., 260° C. and 260° C. respectively and the thermal degradation was complete at about 450° C. The onset (Tₒ) temperatures of the weight loss for 3 types of pure G-polymers are almost the same. There was residue left (char), which turned out to be char mainly from heating G-polymer at high temperatures under nitrogen (FIG. 5a). The char yield remains constant after 450° C. for the three G-polymers. Other chemicals left no char. G-polymers leave no chars when the TGA experiment was conducted under air (FIG. 5b). The Tₒ for pure 1027P, 8042P and 8070P under air are 213.48° C., 246.11° C. and 240.18° C. respectively which are lower than the temperatures under nitrogen.

TABLE 7
TGA data for pure chemicals

| | | Onset | 1^{st} | 2^{nd} | 3^{rd} |
|---|---|---|---|---|---|
| | | Tₒ | Tₘₐₓ | Tₘₐₓ | Tₘₐₓ |
| Sample | Gas | (° C.) | (° C.) | (° C.) | (° C.) |
| Pure 6060D | N₂ | 304.44 | 358.65 | | |
| Pure glycerol | N₂ | 108.68 | 211.51 | | |
| Pure ZnOct | N₂ | 250.42 | 328.58 | | |
| Pure PEGBC | N₂ | 279.37 | 387.48 | | |
| Pure 1027P | N₂ | 245.10 | 305.74 | 355.84 | 420.43 |
| Pure 8042P | N₂ | 250.07 | 303.39 | 424.09 | |
| Pure 8070P | N₂ | 243.15 | 289.62 | 337.08 | 415.19 |
| Pure OKS-1011 | N₂ | 273.53 | 306.06 | 345.06 | 444.35 |
| Pure 1027P | air | 213.48 | 352.9 | 411.23 | 471.55 |
| Pure 8042P | air | 246.11 | 302.47 | 428.04 | 465.62 |
| Pure 8070P | air | 240.18 | 277.75 | 356.85 | 481.44 |

Tₒ: onset temperature of the weight loss peak.
Tₘₐₓ: the temperature of the maximum rate of weight loss

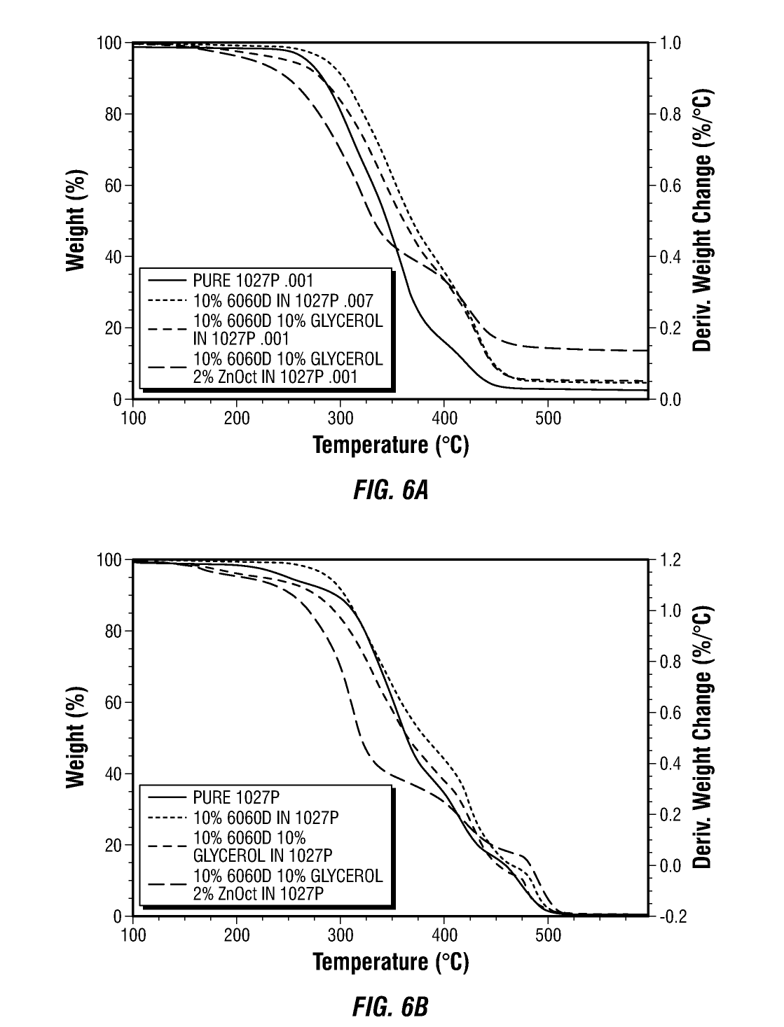

FIG. 6 and Table 8 shows the TGA curves of cross-linked 6060D/1027P samples under both nitrogen and air conditions. As shown in FIG. 6A, the Tₒ for sample 3 is much lower than that for sample 1 and 2, and the rates of weight loss for each of the 3 samples in the temperature range of 375° C. to 480° C. is slower than that for the pure G-polymer. In addition, it shows that the char yield of sample 3 at 600° C. is much higher than that of sample 1 and 2. The slow thermal decomposition at the temperature range of 375° C. to 480° C. may due to the restricted and twisted cross-linking structures which retard the polymer decomposition and increase the thermal stabilities. The char yield is also related to the amount of cross-linking in the samples with higher crosslinking density resulting in higher char yield. The same trend was observed in the TGA curves for samples tested under air. As shown in FIG. 6B, the rate of weight loss is slower in sample 3 than that in sample 1 and sample 2 after about 420° C., and with the increase of cross-linked density, the Tₒ of the degradation is decreased. There are 2 plausible reasons for lower Tₒ: first, more ester bonds were broken for cross-linking, which results in more polyesters with shorter chains; second, the crystallinity is decreased with the increase of cross-linking density, which leads to lower onset temperature of degradation.

TABLE 8
TGA data for cross-linked 6060D/1027P samples

| | | Onset | 1^{st} | 2^{nd} | 3^{rd} |
|---|---|---|---|---|---|
| | | Tₒ | Tₘₐₓ | Tₘₐₓ | Tₘₐₓ |
| Sample | Gas | (° C.) | (° C.) | (° C.) | (° C.) |
| Pure 1027P | N₂ | 245.10 | 305.74 | 355.84 | 420.43 |
| 1a. 10% 6060D | N₂ | 242.46 | 353.20 | 430.98 | |
| in 1027P | | | | | |
| 2a. 10% 6060D | N₂ | 238.50 | 333.42 | 429.66 | |
| 10% glycerol in | | | | | |
| 1027P | | | | | |
| 3a. 10% 6060D | N₂ | 200.27 | 322.88 | 415.16 | 429.66 |
| 10% glycerol | | | | | |
| 10% ZnOct in | | | | | |
| 1027P | | | | | |
| Pure 1027P | air | 213.48 | 352.9 | 411.23 | 471.55 |
| 1b. 10% 6060D | air | 253.03 | 332.13 | 426.07 | 487.37 |
| in 1027P | | | | | |
| 2b. 10% 6060D | air | 246.11 | 329.17 | 431.01 | 478.47 |
| 10% glycerol in | | | | | |
| 1027P | | | | | |
| 3b. 10% 6060D | air | 225.35 | 311.37 | 411.12 | 493.30 |
| 10% glycerol | | | | | |
| 10% ZnOct in | | | | | |
| 1027P | | | | | |

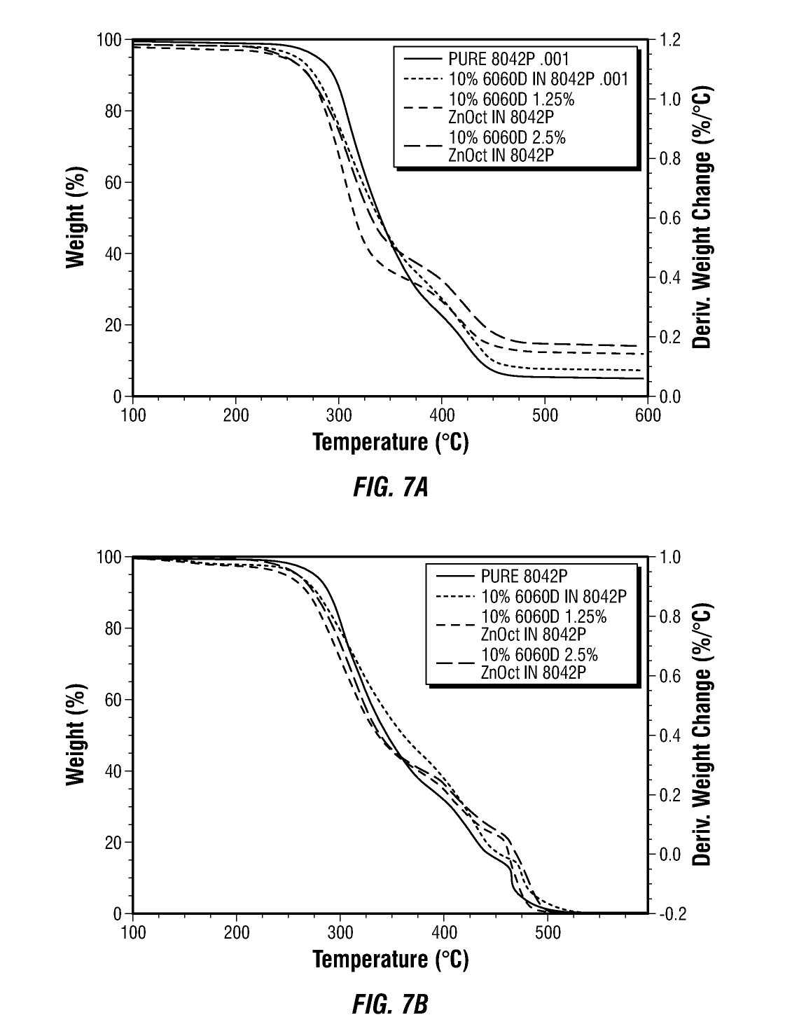

TGA plots for the cross-linked 6060D/8042P samples are shown in FIG. 7 and Table 9. As shown in FIG. 7A, the increase of the amount of ZnOct in the formulation resulted in more chars. As shown in FIG. 7B, weight losses between 375° C. and 475° C. decrease with the increase of the amount of ZnOct in the samples. These experiments suggest that higher loading of catalysts results in higher cross-linking density. This trend is also supported by DSC results.

TABLE 9
TGA data for 6060D/8042P cross-linked samples

| | | | 1^{st} | 2^{nd} | 3^{rd} |
|---|---|---|---|---|---|
| | | Tₒ | Tₘₐₓ | Tₘₐₓ | Tₘₐₓ |
| Sample | Gas | (° C.) | (° C.) | (° C.) | (° C.) |
| Pure 8042P | N₂ | 250.07 | 303.39 | 424.09 | |
| 1a. 10% 6060D in 8042P | N₂ | 234.33 | 308.40 | 413.21 | 434.96 |
| 2a. 10% 6060D | N₂ | 224.36 | 306.43 | 418.76 | |
| 1.25% ZnOct in 8042P | | | | | |
| 3a. 10% 6060D 2.5% | N₂ | 220.41 | 315.43 | 414.20 | 425.08 |
| ZnOct in 8042P | | | | | |
| Pure 8042P | air | 246.11 | 302.47 | 428.04 | 465.62 |
| 1b. 10% 6060D in 8042P | air | 236.85 | 311.09 | 431.6 | 476.92 |
| 2b. 10% 6060D | air | 223.35 | 301.45 | 410.39 | 462.42 |
| 1.25% ZnOct in 8042P | | | | | |
| 3b. 10% 6060D 2.5% | air | 221.42 | 311.09 | 404.61 | 483.67 |
| ZnOct in 8042P | | | | | |

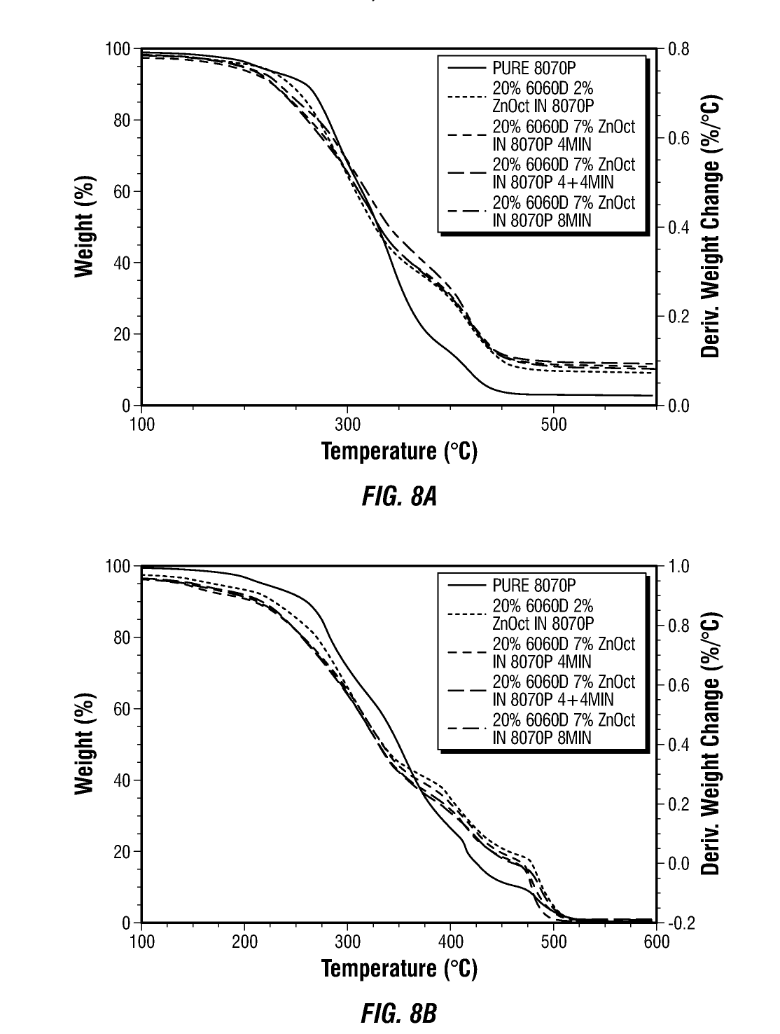

TGA plots and data for cross-linked 6060D/8070P samples are shown in FIGS. 8A and 8B and Table 10. The rate of thermal degradation and the char yield at high temperatures show the similar trend as shown in DSC plots.

TABLE 10
TGA data for cross-linked 6060D/8070P samples

| | | | 1^{st} Tₘ | 2^{nd} Tₘ | 3^{rd} Tₘ | 4^{th} Tₘ |
|---|---|---|---|---|---|---|
| Sample | gas | Tₒ (° C.) | (° C.) | (° C.) | (° C.) | (° C.) |
| Pure 8070P | N₂ | 243.15 | 289.62 | 337.08 | 415.19 | |
| 1. 10%6060D in 8070P | N₂ | 235.1 | 307.42 | 414.2 | 433.98 | |
| 2. 10% 6060D 1% ZnOct in 8070P | N₂ | 224.35 | 306.43 | 414.2 | 426.07 | |
| 3. 20%6060D 2% ZnOct in 8070P | N₂ | 221.1 | 314.15 | 413.2 | 426.34 | |
| 4. 20%6060D 7% ZnOct in | N₂ | 212.75 | 312.69 | 418.11 | | |
| 8070P(4 min) | | | | | | |
| 5. 20%6060D 7% ZnOct in | N₂ | 210.82 | 310.44 | 418.11 | | |
| 8070P(8 min) | | | | | | |
| 6. 20%6060D 7% ZnOct in | N₂ | 214.67 | 259.02 | 323.62 | 420.03 | |
| 8070P(4 + 4 min) | | | | | | |
| Pure 8070P | air | 240.18 | 277.75 | 356.85 | 451.19 | 481.44 |
| 3. 20%6060D 2% ZnOct in 8070P | air | 212.75 | 296.23 | 409.43 | 507.77 | |
| 4. 20%6060D 7% ZnOct in | air | 213.71 | 316.51 | 411.36 | 479.81 | |
| 8070P(4 min) | | | | | | |
| 5. 20%6060D 7% ZnOct in | air | 206.00 | 325.05 | 412.32 | 472.88 | |
| 8070P(8 min) | | | | | | |
| 6. 20%6060D 7% ZnOct in | air | 213.71 | 260.95 | 321.41 | 421.96 | 486.76 |
| 8070P(4 + 4 min) | | | | | | |

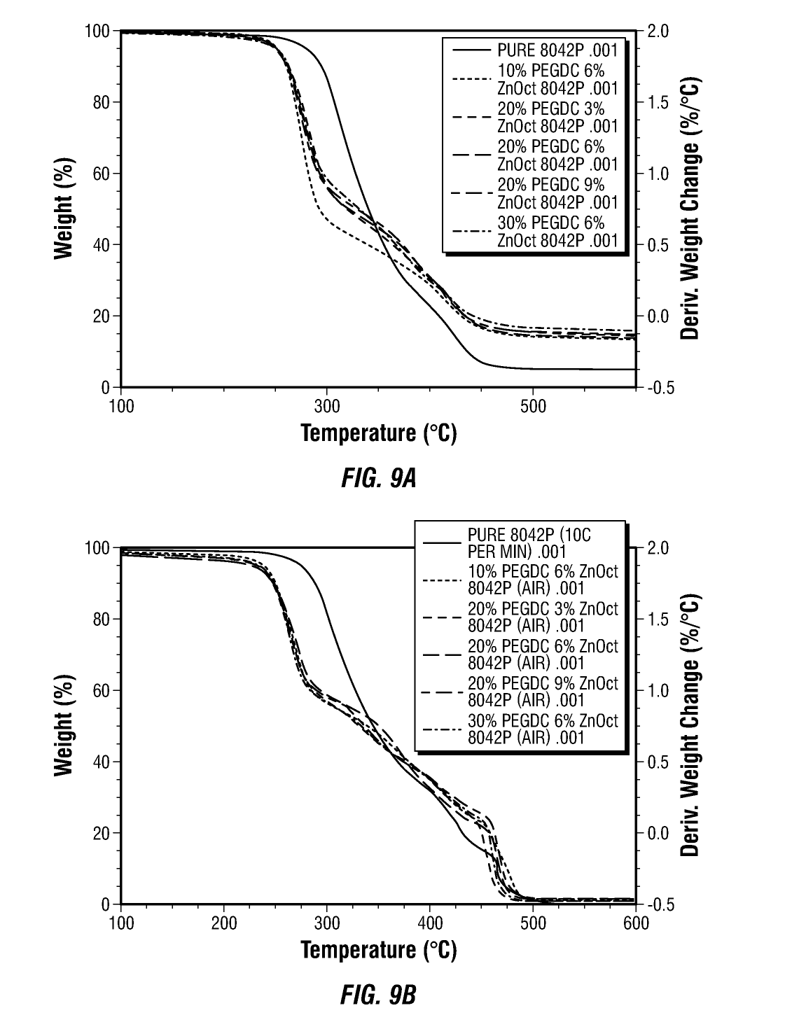

TGA plots and data for cross-linked 6060D/PEGBC samples are shown in FIGS. 9A and 9B and Table 11. The Tₒ and T_{c} are almost the same for each of the 5 samples. The rates of weight loss are also the same for each of the 5 samples.

TABLE 11
TGA data for cross-linked 8042P/PEGBC samples

| | | | 1^{st} Tₘ | 2^{nd} Tₘ | 3^{rd} Tₘ | 4^{th} Tₘ |
|---|---|---|---|---|---|---|
| Sample | gas | Tₒ (° C.) | (° C.) | (° C.) | (° C.) | (° C.) |
| 10% PEGBC 6% | N₂ | 225.42 | 275.42 | 415.48 | | |
| ZnOct in 8042P | | | | | | |
| 20% PEGBC 3% | N₂ | 224.00 | 284.43 | 378.25 | 416.48 | |
| ZnOct in 8042P | | | | | | |
| 20% PEGBC 6% | N₂ | 226.68 | 279.37 | 386.16 | 416.48 | |
| ZnOct in 8042P | | | | | | |
| 20% PEGBC 9% | N₂ | 221.37 | 275.42 | 385.16 | 416.16 | |
| ZnOct in 8042P | | | | | | |
| 30% PEGBC 6% | N₂ | 218.73 | 276.74 | 376.93 | 420.43 | |
| ZnOct in 8042P | | | | | | |
| 10% PEGBC 6% | air | 216.45 | 248.85 | 367.73 | 414.20 | 477.28 |
| ZnOct in 8042P | | | | | | |
| 20% PEGBC 3% | air | 213.48 | 261.93 | 338.07 | 398.38 | 454.74 |
| ZnOct in 8042P | | | | | | |
| 20% PEGBC 6% | air | 213.48 | 270.43 | 317.68 | 417.21 | 464.63 |
| ZnOct in 8042P | | | | | | |
| 20% PEGBC 9% | air | 213.48 | 265.89 | 335.10 | 404.31 | 465.62 |
| ZnOct in 8042P | | | | | | |
| 30% PEGBC 6% | air | 214.47 | 260.94 | 304.72 | 402.28 | 460.67 |
| ZnOct in 8042P | | | | | | |

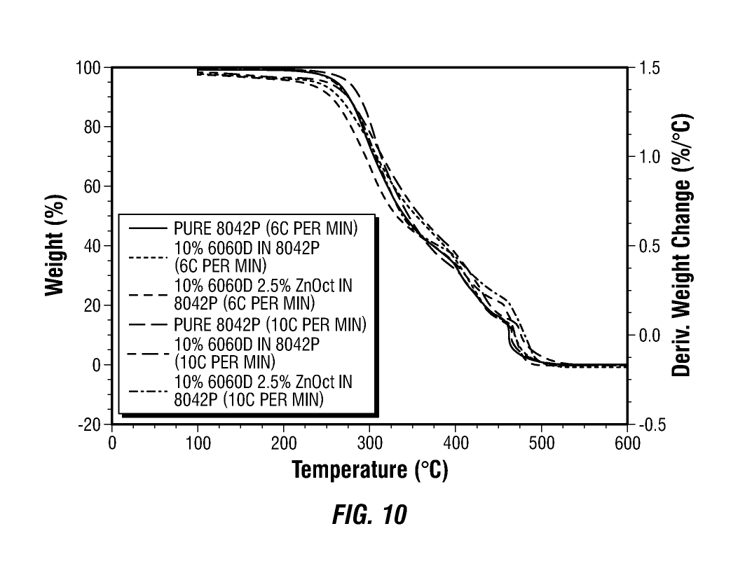

The present inventors also studied the effect of the heating rate on the thermal degradation of the cross-linked samples. The 6060D/8042P cross-linked samples were chosen to be measured by TGA under the heating rate of 6° C./min and 10° C./min. As shown in FIG. 10 and Table 12, the Tₒ and Tₘ are lower at the heating rate of 6° C./min than at the heating rate of 10° C./min.

TABLE 12
TGA data for cross-linked 6060D/8042P samples

| | | | 1^{st} | 2^{nd} | 3^{rd} |
|---|---|---|---|---|---|
| | | Tₒ | Tₘₐₓ | Tₘₐₓ | Tₘₐₓ |
| Sample | gas | (° C.) | (° C.) | (° C.) | (° C.) |
| Pure 8042P (6 C/min) | air | 233.96 | 291.80 | 404.61 | 463.42 |
| 10% 6060D in | air | 227.21 | 308.20 | 420.03 | 470.07 |
| 8042P (6 C/min) | | | | | |
| 10% 6060D 2.5% ZnOct | air | 210.82 | 310.48 | 416.18 | 468.24 |
| in 8042P (6 C/min) | | | | | |
| Pure 8042P (10 C/min) | air | 246.11 | 302.47 | 428.04 | 465.62 |
| 10% 6060D in | air | 236.85 | 311.09 | 431.6 | 476.92 |
| 8042P (10 C/min) | | | | | |
| 10% 6060D 2.5% ZnOct | air | 221.42 | 311.09 | 404.61 | 483.67 |
| in 8042P (10 C/min) | | | | | |

Table 13 show the TGA data of the crosslined OKS-1011 with timer acid as the crosslinker. The T₀ and Tₘ are higher in the crosslinked sample.

TABLE 13
TGA data for cross-linked OKS-1011/Tacid samples

| | | | 1^{st} | 2^{nd} | 3^{rd} |
|---|---|---|---|---|---|
| | | Tₒ | Tₘ | Tₘ | Tₘ |
| | gas | (° C.) | (° C.) | (° C.) | (° C.) |
| G1011 | N₂ | 273.53 | 306.06 | 345.06 | 444.35 |
| G1011-Tacid- | N₂ | 316.5 | 334.42 | 453.19 | |
| ZnOct | | | | | |

### Swelling Studies

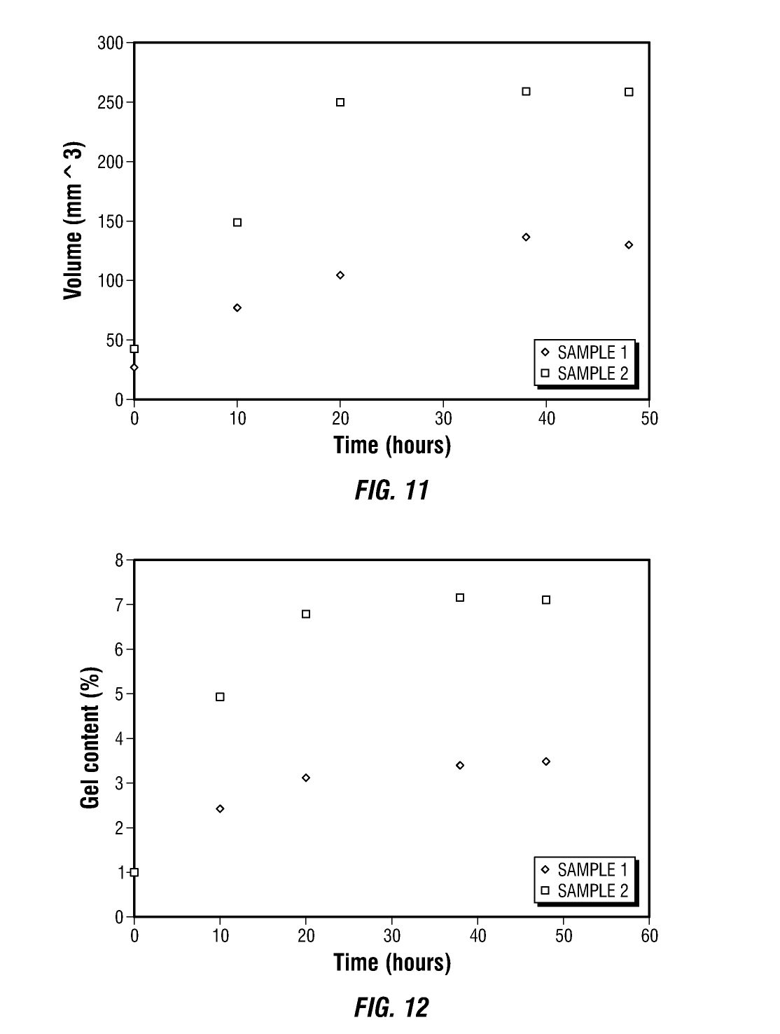

The swelling studies were conducted at both room temperature and 82.5° C. Among the samples, crosslinked 6060D/1027P samples were the only samples that swelled but not dissolve at room temperature. FIG. 11 is the graphical presentation of % swelling of cross-linked 1027P/6060D samples at room temperature. Each of the samples reached the maximum stable swelling after around 48 hours in water, as shown below in Table 14. The sample with glycerol (Sample 2) swelled more than the sample without glycerol (Sample 1) at the same experimental condition (FIG. 11).

TABLE 14
Recordings of the volume swelling versus time

| | | | | | | | Maximum |
|---|---|---|---|---|---|---|---|
| | | | | | | | Degree of |
| | | 0 | 10 | 20 | 38 | 48 | volume |
| Samples | | hour | hours | hours | hours | hours | swelling (%) |
| 1. 10% | Volume (mm³) | 26.82 | 76.86 | 104.6 | 133.6 | 129.89 | 384.3 |
| 6060D in | | | | | | | |
| 1027P | | | | | | | |
| 2. 10% | Volume (mm³) | 42.38 | 149.01 | 250.44 | 259.45 | 258.63 | 510.3 |
| 6060D 10% | | | | | | | |
| glycerol in | | | | | | | |
| 1027P | | | | | | | |

The variation of gel content can be seen in FIG. 12. Sample 2 exhibits much more swelling than sample 1 does. The swelling of cross-linked samples are affected by many factors, such as the cross-linking density, solvent diffusion coefficient and the degree of crystallinity.

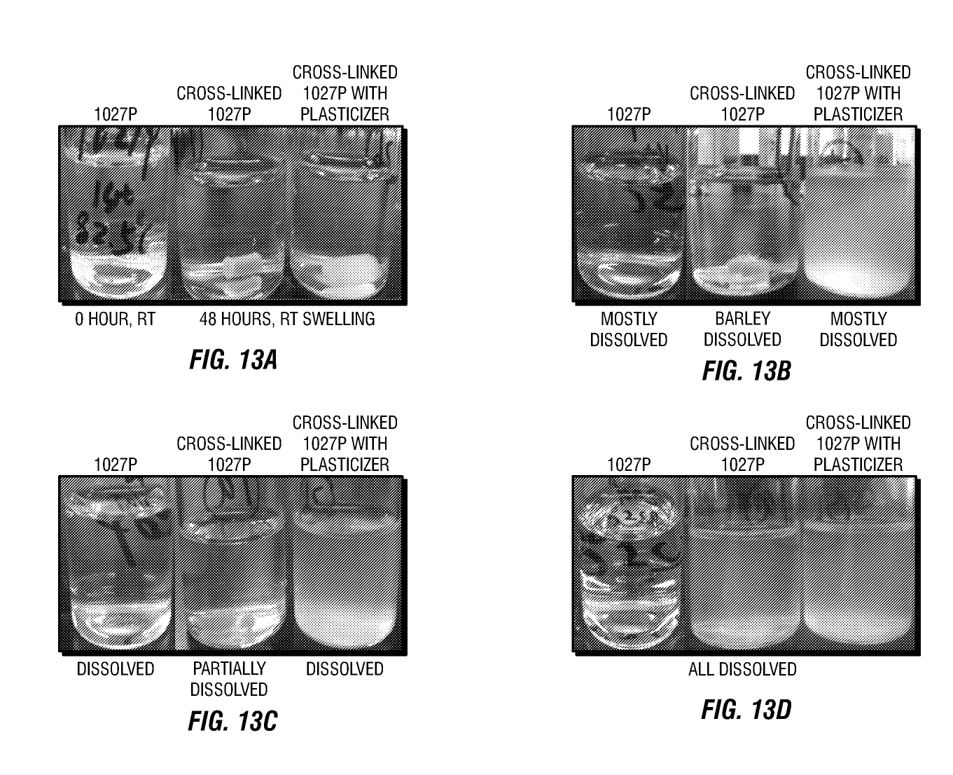

FIG. 13 gives the qualitative description of the rate of dissolution of samples at 82.5° C. The crosslinked 1027P with and without glycerol had been immersed in water at room temperature for about 48 hours and the samples swell but don't dissolve in water (FIG. 13a). After 1 hour in hot water (FIG. 13b), sample 1 and sample 3 are mostly dissolved however sample 2 is barely dissolved. After 6 hours (FIG. 13c), sample 1 and sample 3 were completely dissolved however the main portion of sample 2 remains and completely dissolved after 12 hours at 82° C. (FIG. 13d). This indicates that the build-up of cross-linking structures in sample 2 lower the dissolution rate of pure 1027P.

Although the preceding description has been described herein with reference to particular means, materials and embodiments, it is not intended to be limited to the particulars disclosed herein; rather, it extends to all functionally equivalent structures, methods and uses, such as are within the scope of the appended claims. Furthermore, although only a few example embodiments have been described in detail above, those skilled in the art will readily appreciate that many modifications are possible in the example embodiments without materially departing from the disclosure of DEVELOPMENT AND CHARACTERIZATION OF DEGRADABLE CROSS-LINKING IN PVOH. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112(f) for any limitations of any of the claims herein, except for those in which the claim expressly uses the words ‘means for’ together with an associated function.

What is claimed is:

1. A method of treating a subterranean formation penetrated by a wellbore, the method comprising:
forming a treatment fluid comprised at least a crosslinked polyvinyl alcohol polymer with a crosslinking agent selected from the group consisting of an aliphatic polyester, a semi-aromatic polyester, a derivative of polyalkylene glycol diacid, and combinations thereof, and
introducing the treatment fluid to the subterranean formation.

2. The method of claim 1, wherein the polyvinyl alcohol polymer is a modified polyvinyl alcohol polymer.

3. The method of claim 1, wherein the crosslinking agent is an aliphatic polyester is selected from the group consisting of polylactic acid (PLA), polyglycolic acid (PGA), polyhydroxyalkanoate, poly(3-hydroxybutyrate, and copolymers thereof.

4. The method of claim 3, wherein the aliphatic polyester is PLA.

5. The method of claim 1, wherein the crosslinking agent is a derivative of a polyalkylene glycol diacid prepared from a polyethylene glycol dicarboxylic acid having a molecular weight (Mn, number average) of 200 to 6,000.

6. The method of claim 1, wherein the crosslinking agent is a semi-aromatic polyester selected from the group consisting of polyethylene terephthalate (“PET”), poly(trimethylene terephthalate) (“PTT”), and polybutylene terephthalate (“PBT”), polyethylene naphthalene (“PNT”), and combinations thereof.

7. The method of claim 1, wherein the crosslinking agent is a mixture of a fatty acid dimer and a fatty acid trimer.

8. The method of claim 1, wherein the derivative of the polyalkylene glycol diacid is poly (ethylene glycol) bis (carboxy methyl) ether (PEGBC).

9. The method of claim 1, wherein crosslinked treatment fluid further comprises a metal catalyst.

10. The method of claim 9, wherein the metal catalyst is a metal salt of a fatty acid.
